(19) United States
(12) Patent Application Publication
(10) Pub. No.: US 2016/0120359 A1
(43) Pub. Date: May 5, 2016

(54) Drip Beverage Machine with Brew and Steep Feature

(71) Applicant: Focus Products Group International, LLC, Lincolnshire, IL (US)

(72) Inventors: Chonghui Mao, Guangdong (CN); Rong Liu, Vernon Hills, IL (US); William A. Bucklew, Willmette, IL (US); Li Peixiong, Guangdong Province (CN)

(21) Appl. No.: 14/920,280

(22) Filed: Oct. 22, 2015

(30) Foreign Application Priority Data
Nov. 4, 2014 (CN) 201410617507.1
Nov. 4, 2014 (CN) 201420656993.3

(51) Int. Cl. A47J 31/46

(52) U.S. Cl. CPC A47J 31/46

(57) ABSTRACT

A drip beverage machine allows for steeping and brewing. The machine has a drip valve mounted at a liquid outlet at a bottom of a basket arranged in the machine. An arm may extend from the drip valve. A lever may be provided to actuate the drip valve. One end of the lever may be arranged above the arm, and the other end of the lever may be connected with an acting drive device. The drive device may cause the lever to rotate into abutment against the arm so as to move the drip valve to close the liquid outlet thereby allowing for steeping and brewing of the product in the coffee basket. When steeping and brewing is complete, the drive device may cause the lever to rotate away from the arm so as to open the drip valve and dispense the liquid through the outlet to a pot.

### CROSS-REFERENCE TO RELATED APPLICATIONS

This application claims the benefit of Chinese patent application user. No. 201410617507.1, filed on Nov. 4, 2014, and Chinese patent application user. No. 201420656993.3, filed on Nov. 4, 2014, issued as CN204318456U on May 13, 2015, the disclosures of which are incorporated by reference.

### SUMMARY

The disclosure relates to a drip beverage machine that allows for steeping a product with a liquid. Generally speaking, the product for steeping will be ground coffee and the liquid will be water. However, product may be tea or another product from which a desired extract may be obtained. For ease of description, and not in any limiting sense, the discussion that follows will be with reference to a drip coffee machine.

In a drip coffee machine, after the coffee machine is powered on, a small portion of water from a water tank is heated to boiling by a heating element within the coffee machine. The water is pushed out of a water delivery pipe by vapor pressure and drips into a coffee basket containing ground coffee. The heated water may flow through a distribution plate before entering the coffee basket. From the basket, the liquid flows into a coffee pot, making the coffee for drinking. In one mode of operation of drip coffee machine, water drops drip into the coffee basket and mix with the ground coffee after going through the distribution plate, and then the coffee liquid mixture is directly discharged into a coffee pot. In another mode of operation of the drip coffee machine, the water in retained in the coffee basket to allow for steeping while brewing. After steeping, the coffee liquid mixture may be discharged into a coffee pot.

The drip coffee machine may have a body with a funnel-type coffee basket provided in the body. A drip valve may be mounted at a liquid outlet at the bottom of the coffee basket. A lever may be provided either hinged to the body or the coffee basket. An arm may extend from the drip valve. One end of the lever may be arranged above the arm, and the other end of the lever may be operatively connected with a drive device. When the drive device is actuated, the lever may rotate into abutment against the arm so as to press on the arm and move the drip valve from a normally open position to a closed position to close the liquid outlet and allow for steeping.

A bifurcation or semi-annular plate may be formed at an end of the lever against the arm. The bifurcation or semi-annular plate may fit over the periphery of the drip valve. Two arms may be provided in correspondence with the bifurcation or two ends of the semi-annular plate. A convex ring may be formed on the coffee basket encircling the liquid outlet. The drip valve may be arranged in the convex ring. The bifurcation or semi-annular plate may fit over the peripheral wall of the convex ring. An open slot may be provided in the convex ring. An arm may protrude from the open slot and may abut against the bifurcation or semi-annular plate.

The drive device may be a solenoid actuator operatively connected to an end of the lever. The drive device may be an oil based hydraulic cylinder connected to an end of the lever. The control may be used to control the drive device. The control may generate signals to actuate or deactivate the solenoid actuator of the drive device. The control may be programmable so the drive device operatively engages the lever to close the drip valve for a desired amount of time to allow steeping and by way of example may be set for 30 seconds. The control may also be programmable to adjust the time of actuation. The control may also be operated in a manner to not actuate the solenoid so the drive device and the lever remain stationary with the drip valve in the open position, thereby allowing the one to operate the machine in a conventional brew mode.

When a coffee pot is place on the drip coffee machine, the drip valve is moved to the open position by a convex top portion of the coffee pot. When the coffee machine is started in the steep mode, the drive device causes rotation of the lever into abutment with the arms of the drip valve thereby moving the drip valve from the open position to the closed position to close the liquid outlet. This holds the coffee water mixture inside the basket for proper steeping. After the programmable time is completed, the drive device may release from the lever. When one end of the lever near the drip valve is released, the drip valve is repositioned to open the liquid outlet under the effect of the force convex top portion of the coffee pot.

### BRIEF DESCRIPTION OF THE DRAWINGS

FIG. 1 is a perspective view of a drip coffee machine.

FIG. 2 is another perspective view of the drip coffee machine of FIG. 1.

FIG. 3 is another perspective view of the drip coffee machine showing the coffee basket.

FIG. 4 is a cross-sectional view of coffee machine of FIG. 1.

FIG. 5 is a partial enlarged view of detail area 5-5 of FIG. 4 showing additional detail of a drip valve and lever.

FIG. 6 is a perspective view of the lever for actuating the drip valve.

FIG. 7 is another perspective view of the lever of FIG. 6.

FIG. 8 is another partial cross-sectional view of a upper housing of the coffee machine showing the location of a controller for the drip valve.

FIG. 9 is perspective view of the coffee basket, lever, and arms associated with the drip valve.

FIG. 10 is another perspective view of the coffee basket, lever, and arms associated with the drip valve, along with the drive device on a proximal end of the lever.

FIG. 11 is another partial, perspective view of the coffee basket, lever, and arms associated with the drip valve, along with the drive device on a proximal end of the lever, and the coffee pot.

FIG. 12 is another partial, perspective view of the coffee basket, lever, arms associated with the drip valve, the drive device on a proximal end of the lever, and the coffee pot.

FIG. 13 is another partial, perspective view of the coffee basket, lever, arms associated with the drip valve, the drive device on a proximal end of the lever, and the coffee pot.

FIG. 14 is a partial, cut-away perspective view showing additional detail of the coffee pot.

FIG. 15 is a partial, cut-away perspective view showing additional detail of the coffee basket, drip valve, arms associated with the drip valve, the lever.

FIG. 16 is a partial, cut-away perspective view showing additional detail of the coffee pot, coffee basket, drip valve, arms associated with the drip valve, the lever, and the drive device.

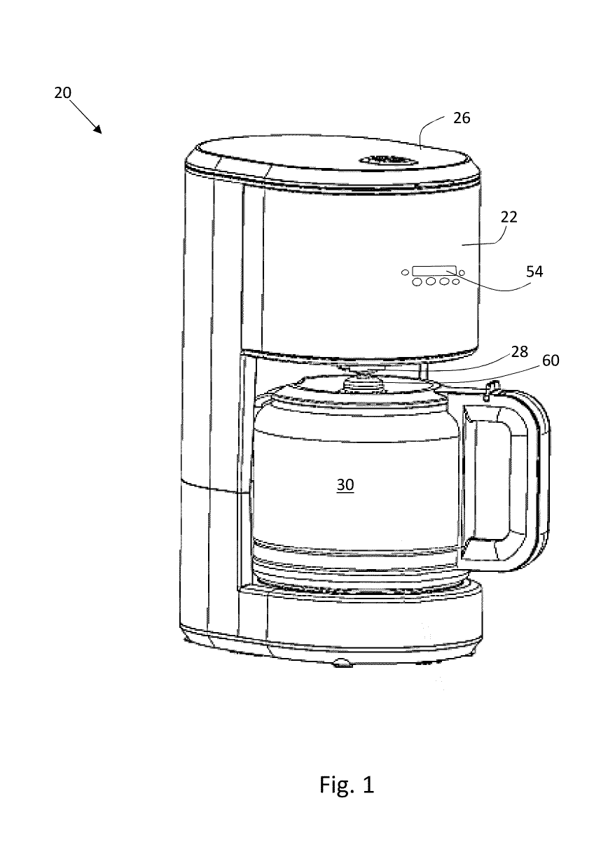

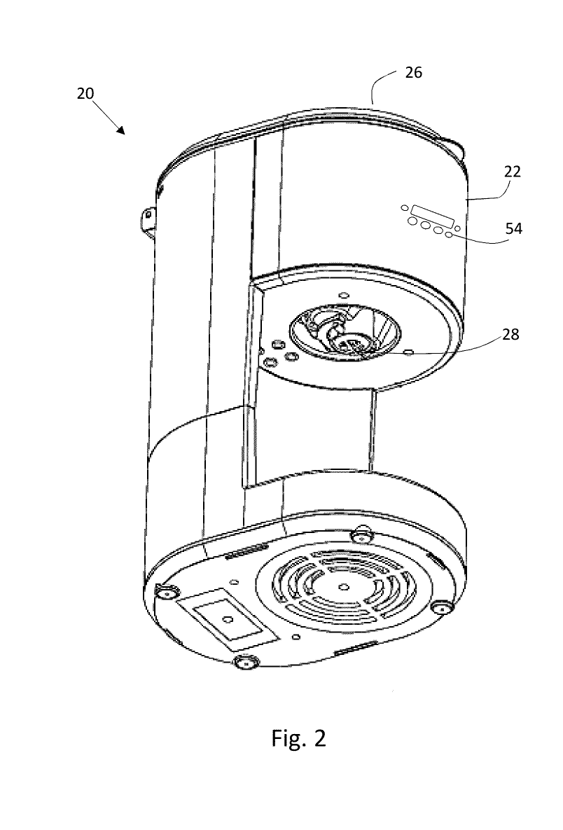

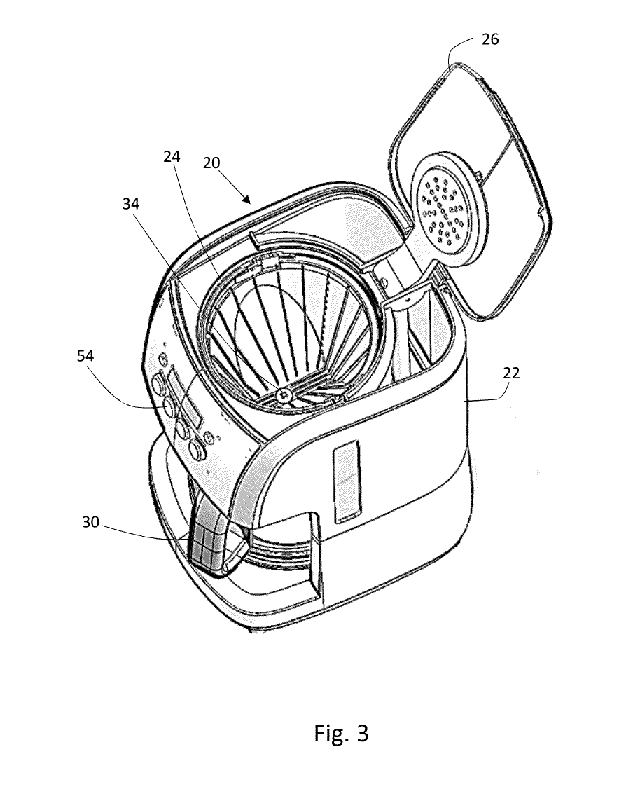

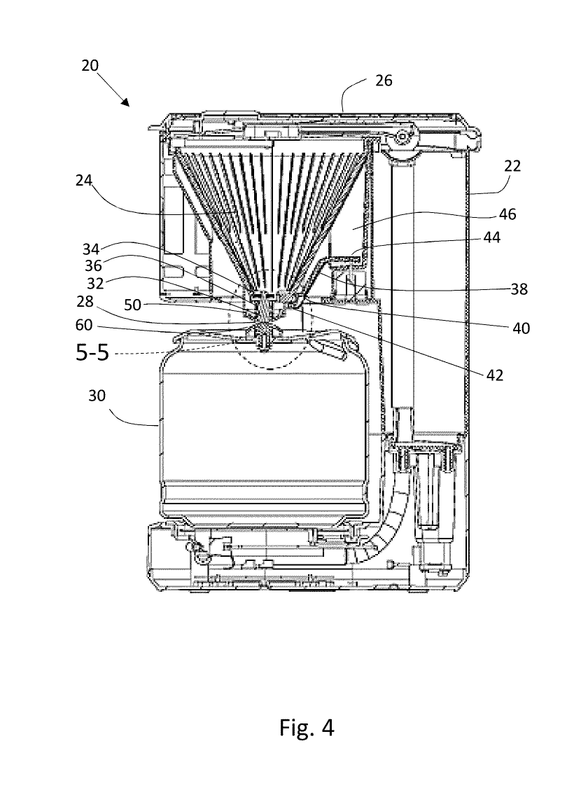

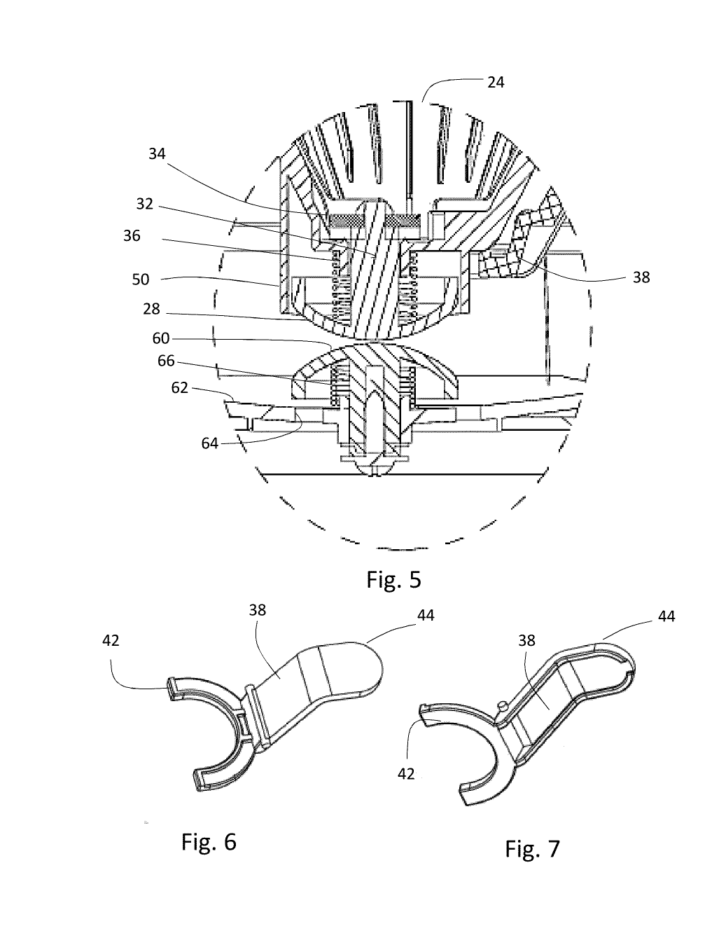

### DETAILED DESCRIPTION

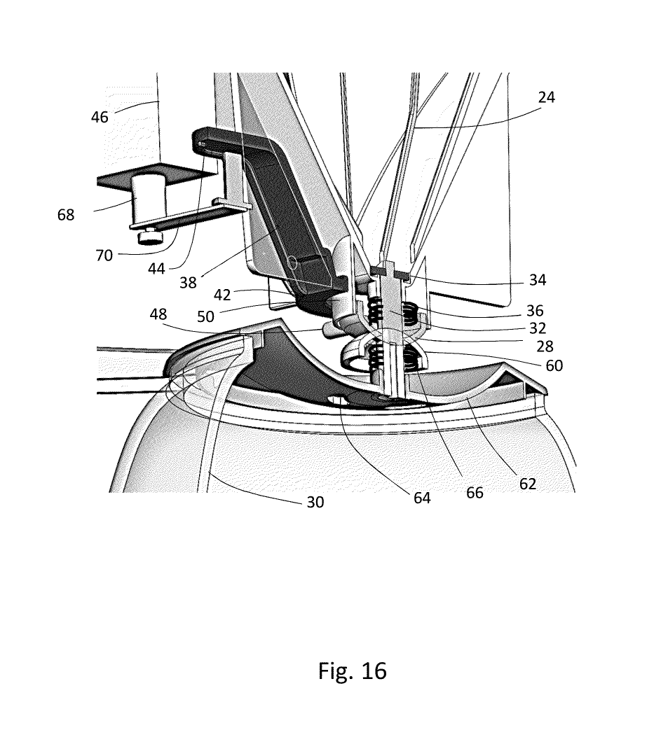

The drip coffee machine 20 comprises a body 22 with a funnel-type coffee basket 24 provided in a cavity formed in an upper portion of the body. A lid 26 hingedly connected to the upper portion of the body may be provided to close the cavity and extend over the coffee basket 24. A drip valve 28 may be mounted at a liquid outlet at the bottom of the coffee basket. A coffee pot 30 may be provided under the drip valve 28. The drip valve 28 may comprise a valve body 32 with a sealing ring portion 34 connected thereto extending into the basket interior. A biasing member 36, such as a coil spring, may be fitted over the valve body 32 to bias the valve body in a manner such that the valve body and sealing ring portion 34 abut against the interior of the coffee basket 24, i.e., downward in the pictures, when the coffee pot 30 is not located under the drip valve 28. As explained later, placing a coffee pot 30 under the drip valve 28 will force the valve body 32 in such a manner (e.g., upward in the drawings) that the sealing ring portion 34 will be positioned away from the interior of the basket 24 against pressure from the biasing member 36. In particular, as shown best in FIG. 16, after placement of the coffee pot 30 under the drip valve 28, a biasing member 66 may bias a convex top portion 60, which may extend from a lid 62 of the coffee pot at the top of the coffee pot, to abut against the valve body and push the valve body in a manner such that the sealing ring 34 is positioned away from the interior of the coffee basket 24 to open the liquid outlet in the coffee basket and to allow the coffee liquid mixture to flow to the coffee pot.

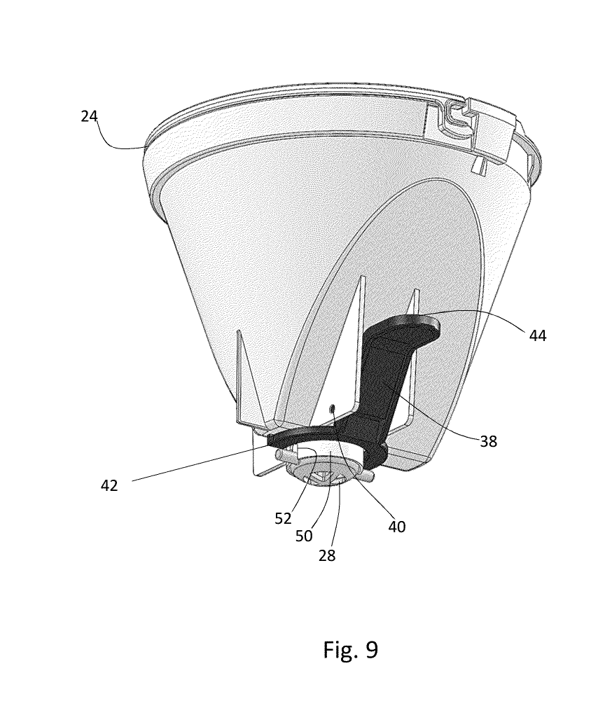

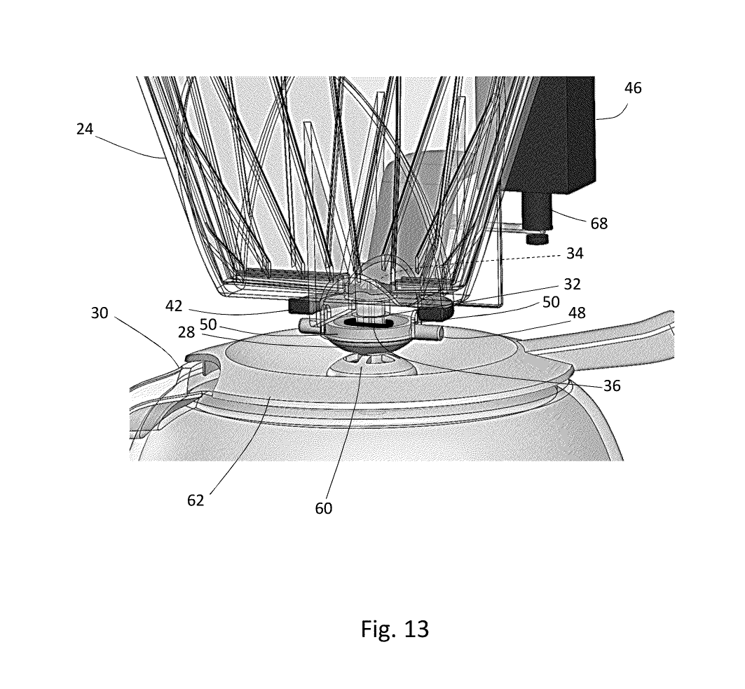

The drip coffee machine 20 may have a lever 38 for actuating the drip valve. The lever 38 may be hingedly connected to the body or the coffee basket. In the drawings, the lever 38 is hingedly connected to the coffee basket 24 at a pivot 40. The lever 38 may have a distal end 42 for operatively engaging the drip valve 28 and a proximal end 44 for operatively engaging a drive device 46. The lever distal end 42 may have a bifurcation or semi-annular plate for operatively engaging the drip valve 28. The drip valve 28 may have a lever engagement portion 48. As shown in the drawings, the lever engagement portion 48 comprises two arms operatively connected to the valve body 32. As best shown in FIGS. 9-10, and 13, the arms 48 extend from the valve body 32 of the drip valve 28, and the bifurcation or ends of the semi-annular plate at the distal end 42 of the lever are arranged above the arms. When the drive device 46 is actuated, the lever 38 rotates so as to abut the arms 48 of the drip valve 28 and to move the valve body 32 from a normally open position to a closed position with the sealing ring 34 abutting the interior surface of the coffee basket 24 to close the liquid outlet of the coffee basket (e.g., downwardly as shown in the drawings). The semi-annular plate 42 may be arranged to fit around and over the outer periphery of the drip valve 28. Providing the bifurcation or semi-annular plate 42 with opposed arms 48 may distribute force more evenly between the lever and the opposed arms, thereby reducing activation noise and ensuring more reliable actuation of the drip valve of the coffee machine, as opposed to a single point contact between the lever and the drip valve. A convex ring structure 50 may be formed on the coffee basket and encircling the liquid outlet. The drip valve 28 may be mounted within the convex ring structure 50. The bifurcation or semi-annular plate 42 may be shaped to fit around the convex ring structure 50. An open slot 52 may be provided in the convex ring structure 50, and the arms 48 may protrude from the open slot to allow engagement with the bifurcation or the semi-annular plate 42. The convex ring structure 50 may define a housing to accommodate and protect the drip valve 28, while providing a guide surface for the bifurcation or semi-annular plate 42, thereby facilitating smooth movement of the drip valve.

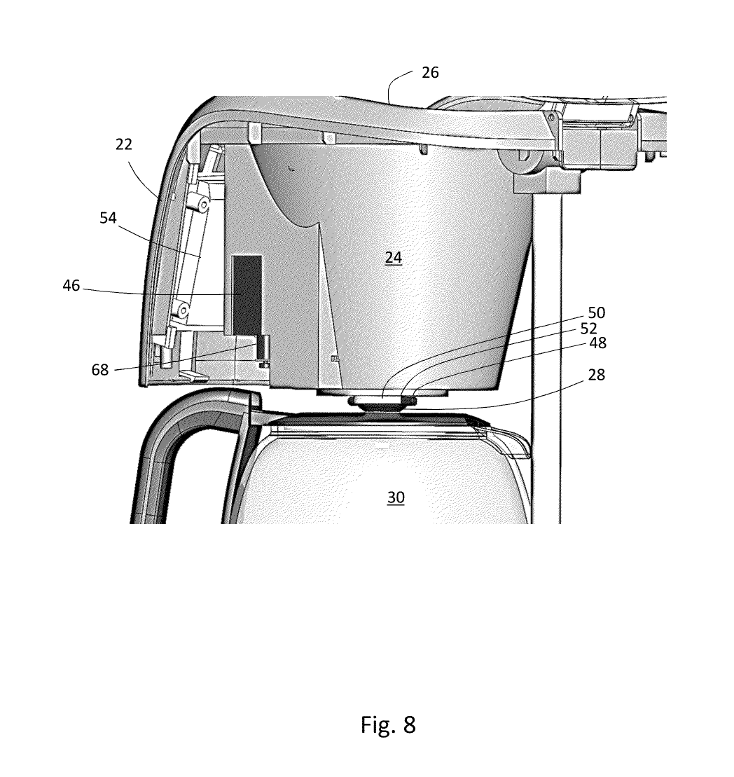

The drive device 46 may be a solenoid or an oil hydraulic cylinder with an actuator 68. The drive device 46 may be operatively connected to the proximal end 44 of the lever 38. A control 54 for the drive device 46 may comprise a printed circuit board. The drive device 46 and control 54 may receive power from the main power supply of the coffee machine. As best shown in FIG. 8, the control 54 and drive device 46 may be mounted within an upper portion of the housing 22. The control 54 may be programmed to allow a “brew only” mode and a “brew and steep” mode.

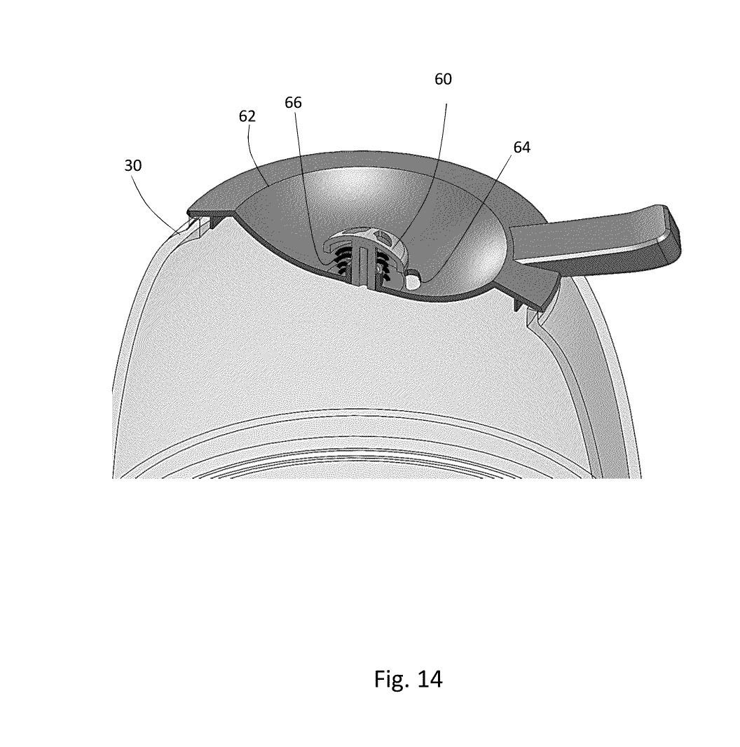

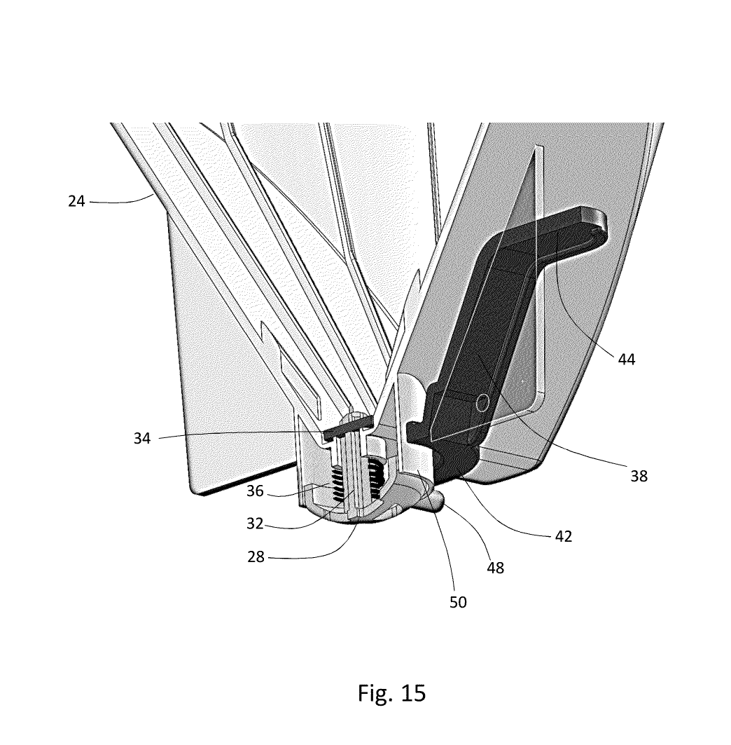

The coffee pot 30 comprises a hollow vessel configured to receive the coffee liquid mixture from the coffee basket 24 through the basket outlet, sealing ring 34 and drip valve 28 mounted adjacent thereto. The coffee pot 30 may have a convex top portion 60 at its top. The convex top portion 60 may extend from a lid 62 over the top of the coffee pot 30. The lid 62 of the coffee pot 30 may have a plurality of apertures 64 about the convex top portion 60 to allow coffee liquid mixture to flow into the interior of the coffee pot through the lid and coffee basket liquid outlet. The convex top portion 60 may have a biasing member 66, e.g., a coil spring, to force the convex top portion away from the top of the coffee pot, for instance, upward in FIGS. 14 and 16. The force generated by the biasing member 66 adjacent to the convex top portion 60 may be greater than the force generated by the biasing member 36 of the drip valve 28. Thus, when the coffee pot 30 is placed under the drip valve 28, the biasing member 66 of the coffee pot convex top portion 60 may move the valve body 28 such that sealing ring 34 is positioned away from the interior surface of the coffee basket 24 (e.g., upward in the drawings) against the pressure exerted by the drip valve biasing member 36, and when the coffee pot 30 is removed from under the drip valve 28, the valve body 32 may move to position the sealing ring 34 against the interior surface of the coffee basket (e.g., downward in the drawings) by action of the drip valve biasing member 36.

The “brew only” and “brew and steep” modes of operation will be discussed next. When the coffee pot 30 placed on the drip coffee machine under the drip valve 28, the valve body 32 of drip valve may be moved (for instance, lifted in the drawings) by the convex top portion 60 of the coffee pot. The movement of the valve body 32 effects motion such that the sealing ring 34 moves away from the interior surface of the coffee basket 24 thereby opening the liquid outlet of the coffee basket. In this position, the arms 48 of the valve body of the drip valve 28 may be moved into abutment against the underside of the lever 38 (i.e., upward in the drawings). In the “brew” only mode, the drive device 46 is not actuated. Hot water drops fill the coffee basket, and the coffee liquid mixture flows through the open liquid outlet of the coffee basket into the coffee pot.

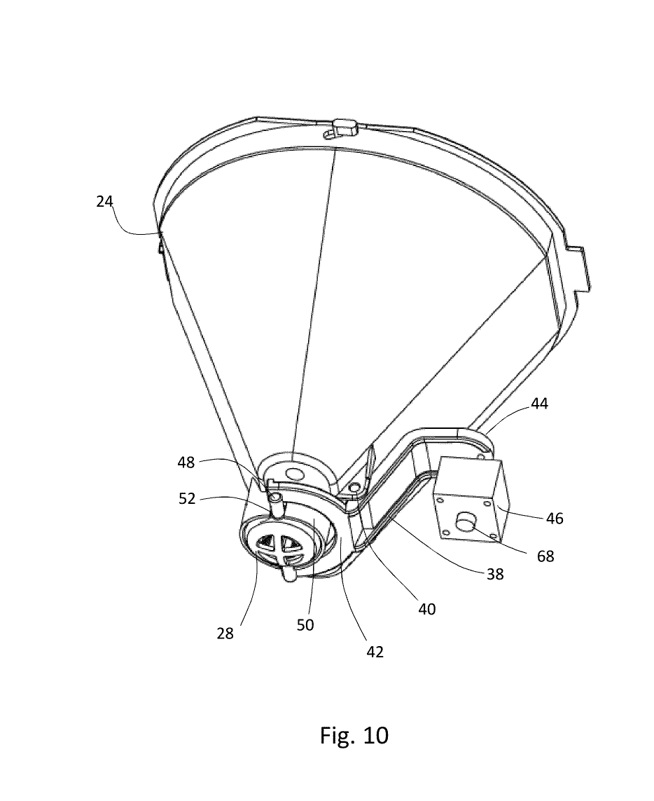

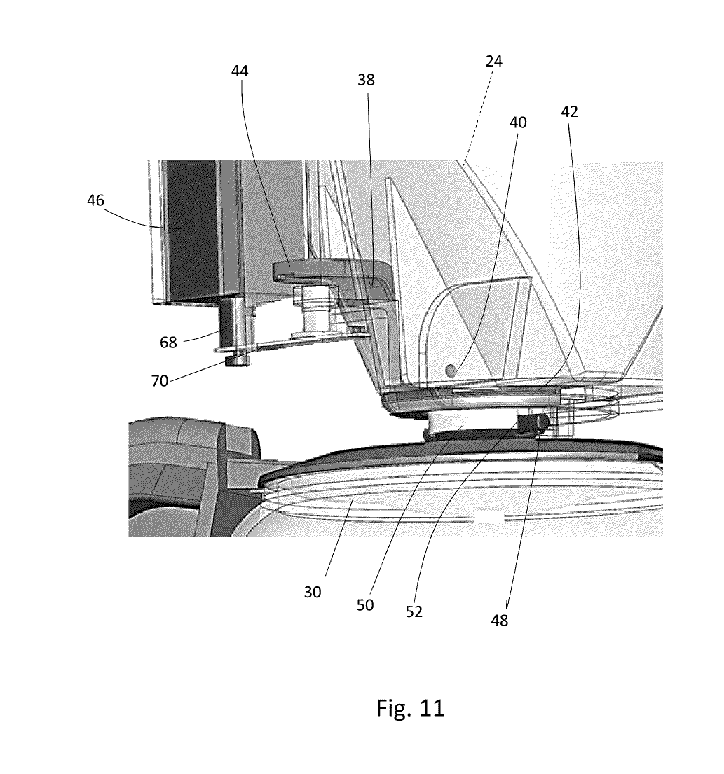

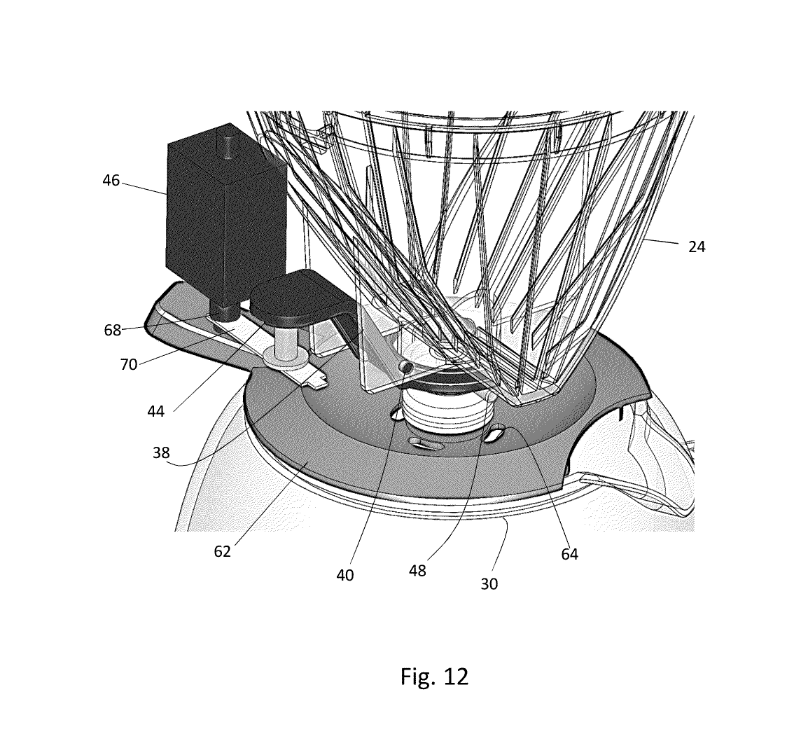

In the “brew and steep” mode, the control 54 send control signals to the drive device 46 to actuate and deactivate the drive device. The control 54 sends signals to actuate the drive device 46 and reposition an actuator 68 of the drive device to cause rotation of the lever arm 38. The control 54 may actuate the drive device 46 for one programmed time (for example, 30 seconds) or a series programmed time (for example, 3 sets of 10 seconds of actuation followed by 3 seconds of non-actuation). FIG. 10 shows one embodiment where the actuator 68 of the drive device 46 is directly coupled to the proximal end 44 of the lever 38. In FIG. 10, the actuator 68 may move upward to force the proximal end 44 of the lever up and to move the distal end 42 of the lever into engagement with the arms 48 of the drip valve. In FIGS. 11-12, the actuator 68 may move upward in the drawings causing a bridging member 70, connected to the proximal end 44 of the lever, and the proximal end of the lever to move upward, and to move the distal end 42 of the lever into engagement with the arms 48 of the drip valve. The bridging member 70 allows the control 54, drive device 46, and actuator 68 to be spaced from the lever. Whether a bridging member 70 is provided, the hinged action of the lever 38 pushes against the arms 48 of the drip valve, moving the valve body 32 and the sealing ring 34 against the interior surface of the coffee basket 24 to close the liquid outlet of the coffee basket. The motion of the lever 38 (e.g., downward in the drawings) overcomes the pressure of the biasing member 66 of the coffee pot convex top portion 60, so that the valve body 32 may engage against the coffee pot convex top portion and force the convex top portion toward the top of the coffee pot (e.g., downward in the drawings). The coffee basket 24 may partially fill with hot water allowing for steeping of the coffee liquid.

After the programmed actuation time is complete, the control 54 may deactivate the drive device 46, and the actuator 68 may return to its normal position, for instance, downward in the drawings. The downward motion of the actuator 38 may cause downward motion for the proximal end 44 of the lever and upward motion of distal end 42 of the lever. The upward motion of the distal end 42 of the lever causes the semi-annular plate 42 to release from the arms 48 of the drip valve. The coffee pot convex top portion biasing member 66 may force the valve body 32 to a position where the coffee basket sealing ring 34 moves away from the interior surfaces of the coffee basket, thereby opening the coffee basket liquid outlet and allowing the coffee liquid mixture to flow therethrough in to the coffee pot.

In view of the foregoing, it will be seen that the several advantages of the invention are achieved and attained. The embodiments were chosen and described in order to best explain the principles of the disclosure and their practical application to thereby enable others skilled in the art to best utilize the principles in various embodiments and with various modifications as are suited to the particular use contemplated. As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A drip beverage machine comprising:
a body;
a basket provided in the body, the basket having a liquid outlet and being configured to contain a product to be steeped and liquid for steeping of the product;
a drip valve movable between an open position to permit flow of the steeped liquid through the liquid outlet of the basket and a closed position to prevent flow through the liquid outlet of the basket;
a pot having a drip valve engagement portion movable between and extended position and a retracted position;
a lever portion configured to cooperate with the drip valve for positioning the drip valve to permit and prevent flow through the liquid outlet; and
a control configured to actuate the lever in a manner such that (i) the drip valve moves to the closed position and the pot drip valve engagement portion moves to the retracted position to allow steeping of the product with the liquid, and (ii) the drip valve moves to the open position and the pot drip valve engagement portion to the extended position to allow the steeped liquid to flow through the liquid outlet and the drip valve into the pot.

2. The machine of claim 1 wherein the lever operatively engages the drip valve to move the drip valve to the closed position.

3. The machine of claim 1 wherein the lever releases from the drip valve to allow the drip valve to move to the open position.

4. The machine of claim 1 wherein the drip valve has a biasing member that urges the drip valve to the closed position.

5. The machine of claim 1 wherein the pot drip valve engagement portion has a biasing member that urges the drip valve engagement portion to the extended position.

6. The machine of claim 1 wherein the drip valve has a sealing ring that contacts an interior surface of the basket when the drip valve is in the closed position.

7. The machine of claim 1 wherein in the drip valve has an arm that engages with the lever when the drip valve moves to the closed position.

8. The machine of claim 1 wherein the lever is hingedly connected with the basket.

9. The machine of claim 1 wherein the lever has a bifurcated end which extends around the drip valve.

10. The machine of claim 9 wherein the bifurcated end of the lever engages respective arms of the drip valve in moving the drip valve to the closed position.

11. The machine of claim 10, wherein the drip valve has an exterior that complements a shape of the bifurcated end of the lever.

12. A drip beverage machine comprising:
a body;
a basket provided in the body, the basket having a liquid outlet and being configured to contain a product to be steeped and liquid for steeping of the product;
a drip valve movable between an open position to permit flow of the steeped liquid through the liquid outlet of the basket and a closed position to prevent flow through the liquid outlet of the basket;
a lever portion configured to cooperate with the drip valve for positioning the drip valve to permit and prevent flow through the liquid outlet; and
a drive device configurable between one of moving and not moving the lever, in the moving the lever, the drive device being configurable to move the lever to (i) engage the drip valve to move the drip valve to the closed position to allow steeping of the product with the liquid, and (ii) disengage from the drip valve to allow the drip valve to move to the open position to allow the steeped liquid to flow through the liquid outlet.

13. The machine of claim 12 wherein the drip valve has a biasing member that urges the drip valve to the closed position.

14. The machine of claim 12, wherein the drip valve has an exterior that complements a shape of the bifurcated end of the lever.

15. The machine of claim 12, further comprising a bridging member extending between the drive device and the lever.

16. The machine of claim 12, wherein with the drive device configurable to not move the lever, the drip valve is open thereby allowing liquid to flow through the basket liquid outlet.

17. The machine of claim 12, wherein the drive device is selectively configurable to move the lever such that the drip valve is closed for a selected time period.

18. A drip beverage machine comprising:
a body;
a basket provided in the body, the basket having a liquid outlet and being configured to contain a product to be steeped and liquid for steeping of the product;
a drip valve movable between an open position to permit flow of the steeped liquid through the liquid outlet of the basket and a closed position to prevent flow through the liquid outlet of the basket;
a lever portion configured to cooperate with the drip valve for positioning the drip valve to permit and prevent flow through the liquid outlet; and
a drive device configurable between one of moving and not moving the lever, in the moving the lever, the drive device being configurable to move the lever to (i) engage the drip valve to move the drip valve to the closed position to allow steeping of the product with the liquid, and (ii) disengage from the drip valve to allow the drip valve to move to the open position to allow the steeped liquid to flow through the liquid outlet.
a control configurable between one of moving and not moving the lever, in the moving the lever, the control being configurable to move the lever to (i) engage the drip valve to move the drip valve to the closed position to allow steeping of the product with the liquid, and (ii) disengage from the drip valve to allow the drip valve to move to the open position to allow the steeped liquid to flow through the liquid outlet.

19. The machine of claim 18, wherein with the control configurable to not move the lever, the drip valve is open thereby allowing liquid to flow through the basket liquid outlet.

20. The machine of claim 18, wherein the control is selectively configurable to move the lever such that the drip valve is closed for a selected time period.
